(19) United States
(12) Patent Application Publication
(10) Pub. No.: US 2018/0113273 A1
(43) Pub. Date: Apr. 26, 2018

(54) CAMERA ACTUATOR AND CAMERA MODULE FOR MOBILE TERMINAL

(71) Applicant: RDK EMD CO., LTD, Ansan-si Gyeonggi-do (KR)

(72) Inventors: Deok Yul LEE, Ansan-si, Gyeonggi-do (KR); Jae Wook RYU, Seoul (KR); Ju Hyun JEON, Ansan-si, Gyeonggi-do (KR); Eun CHO, Ansan-si, Gyeonggi-do (KR)

(21) Appl. No.: 15/569,654

(22) PCT Filed: Dec. 13, 2016
(86) PCT No.: PCT/KR2016/014609

§ 371 Date: Oct. 26, 2017

(30) Foreign Application Priority Data
Feb. 1, 2016 (KR) 10-2016-0012362

(51) Int. Cl. G02B 7/09; H04N 5/225

(52) U.S. Cl. CPC G02B 7/09; H04N 5/2254; H04N 5/2257

(57) ABSTRACT

Provided is a camera actuator and a camera module for a mobile terminal, which move a lens along an optical axis direction, and more particularly, to a camera actuator and a camera module for a mobile terminal, in which even when a support spring and a driving source configured to generate driving force are located on one side of a lens, when the lens vertically moves along an optical axis direction, a displacement by which a lens center is moved in a horizontal direction from an initial position thereof is minimized, so that the lens center is located on a line of an initial optical axis, and which include an elastic part including a first elastic part connected to a fixed part to extend in a first direction, and a second elastic part bent from an extending end of the first elastic part, extending in a second direction that is opposite to the first direction, and having an extending end connected to a movable part.

### TECHNICAL FIELD

The present invention relates to a camera actuator and a camera module for a mobile terminal, which move a lens along an optical axis direction, and more particularly, to a camera actuator and a camera module for a mobile terminal, in which even when a support spring and a driving source configured to generate driving force are located on one side of a lens, when the lens vertically moves along an optical axis direction, a displacement by which a lens center is moved in a horizontal direction from an initial position thereof is minimized, so that the lens center is located on a line of an initial optical axis.

### BACKGROUND ART

Most of mobile terminals such as a smart phone, which have recently released, include camera functions. In such a camera for a mobile terminal, to obtain an optimal resolution, a distance between a lens and an image sensor should be changed depending on a distance between the camera and an object to be photographed. In particular, when a user wants to obtain a high-quality image having a high resolution, devices for correcting a focal distance of the lens are necessarily mounted. Such correction of the focal distance may be classified into manual correction in which a person who takes a picture manually corrects the focal distance and automatic correction in which a device provided in a camera lens module automatically corrects the focal distance.

In this way, the conventional camera actuator for a mobile terminal, for automatically correcting a focus, has a disadvantage in that because upper and lower leaf springs are fixed to a housing, a structure of the camera actuator is complex, and because circuits for driving the lens should be provided on a lower surface and a lateral surface, assembly is complex.

Meanwhile, a camera lens assembly for implementing miniaturization and low costs of a camera lens assembly while a high-level image quality is maintained is disclosed in Korean Patent Application Publication No. 10-2014-008169.

The conventional camera lens assembly includes: a lens holder 120 on which a lens module 110 is mounted; a wire member 130 fixed to the lens holder and the lens module to elastically support the lens module so as to drive the lens module in an optical axis direction; and a fixing member 140 mounted on the lens holder to fix the wire member, and configured to damp an impact generated in the wire member due to an impact generated in a direction that is perpendicular to the optical axis direction.

However, in the conventional camera lens assembly, when the lens module vertically moves along the optical axis direction while the wire member is elastically deformed, a lens center deviates from a line of an initial optical axis while the wire member is elastically deformed. That is, a problem occurs in that as the lens module moves vertically, the lens moves transversely with respect to the optical axis, the lens center does not coincide with the center of an image sensor, and thus, image quality is degraded.

### DISCLOSURE

### Technical Problem

The present invention is conceived to solve the above-described problem, and an aspect of the present invention is to provide a camera actuator and a camera module for a mobile terminal, in which even when a support spring and a driving source configured to generate driving force are located on one side of a lens, when the lens vertically moves along an optical axis direction, a displacement by which a lens center is moved in a horizontal direction from an initial position thereof is minimized, so that the lens center is maintained on a line of an initial optical axis.

### Technical Solution

To achieve the above aspect, a camera actuator for a mobile terminal according to the present invention may include an elastic part including a first elastic part connected to a fixed part to extend in a first direction, and a second elastic part bent from an extending end of the first elastic part, extending in a second direction that is opposite to the first direction, and having an extending end connected to a movable part.

Further, when the movable part is raised, as the first elastic part is elastically deformed while taking one end of the first elastic part, which is fixed to the fixed part, as a support point, an opposite end of the first elastic part may be raised, and as the second elastic part is elastically deformed while taking an inflection point connected to the first elastic part as a support point, ends of the second elastic part may be raised, so that a lens center of a lens assembly is always close to an initial optical axis.

Further, the elastic part may be divided into a left elastic part and a right elastic part, which are located on opposite sides with respect to the movable part, and ends of the second elastic part of the left elastic part and the second elastic part of the right elastic part may be connected to each other through a first bridge.

Further, an upper mounting part, on which the second elastic part is fixedly mounted, may protrude from an upper portion of the movable part to form a step with the upper surface of the movable part, and the remaining portion of the second elastic part except for a portion of the second elastic part, which is located above the movable part and is fixed to the upper mounting part, may be spaced apart from the movable part.

Further, an upper assembly protrusion and a filling groove may be formed in the upper mounting part, an assembly hole into which the upper assembly protrusion is inserted and an adhesion hole corresponding to the filling groove may be formed in the second elastic part, and adhesive may be filled in the filling groove and the adhesion hole to fix the second elastic part to the upper mounting part.

Further, the first elastic part may include a first elastically deformed part having one end mounted on the fixed part, and protruding in the first direction, and a second elastically deformed part having one end extending from an opposite end of the first elastically deformed part, and protruding in the first direction, wherein the second elastic part is bent from the second elastically deformed part to protrude in the second direction, and the width of the first elastically deformed part and the width of the second elastically deformed part are different from each other.

Further, the camera actuator for a mobile terminal according to the present invention may further include a lower elastic part located below the movable part, wherein the lower elastic part includes a first lower elastic part connected to the fixed part and extending in the first direction, a second lower elastic part bent from an extending end of the first lower elastic part, extending in the second direction, and connected to the movable part, and a lead part extending from the second lower elastic part and electrically connected to a coil part.

Meanwhile, a camera actuator for a mobile terminal according to the present invention may include an elastic part including a first elastic part connected to a fixed part to extend in a first direction, and a second elastic part bent from an extending end of the first elastic part, extending in a second direction that is opposite to the first direction, and having an extending end connected to a movable part.

### Advantageous Effects

In the camera module and the camera module for a mobile terminal according to the present invention, when a lens assembly vertically moves along an optical axis direction together with a movable part, a displacement by which a lens center is moved in a horizontal direction from an initial position thereof is minimized, and thus, while the lens center is located in a line of an initial optical axis, distortion of an optical axis is minimized, so that imaging quality may be improved.

Further, the present invention has a structure in which a movable part to which a lens assembly is coupled is supported by an elastic part biased from a lens. It is easy to drive the movable part even using a relatively weak electromagnetic force, and accordingly, it is advantageous to simplify or miniaturize the structures of the actuator and the module.

### DESCRIPTION OF THE DRAWINGS

FIG. 1 is a perspective view illustrating a camera lens assembly according to the related art;

FIG. 2 is a perspective view illustrating a camera actuator for a mobile terminal according to an embodiment of the present invention;

FIG. 3 is an exploded perspective view illustrating a camera actuator for a mobile terminal according to the embodiment of the present invention;

FIG. 4 is a perspective view illustrating the camera actuator for a mobile terminal of FIG. 2, from which a holder and a cover are removed;

FIG. 5 shows a plan view and a bottom view illustrating the camera actuator for a mobile terminal, from which the holder, the cover, and an elastic part are removed;

FIG. 6 is a view separately illustrating an upper elastic part according to the embodiment of the present invention;

FIG. 7 is a view separately illustrating a lower elastic part according to the embodiment of the present invention; and

FIGS. 8 and 9 are views schematically illustrating operations of the movable part and the elastic part according to the embodiment of the present invention in comparison with the related art.

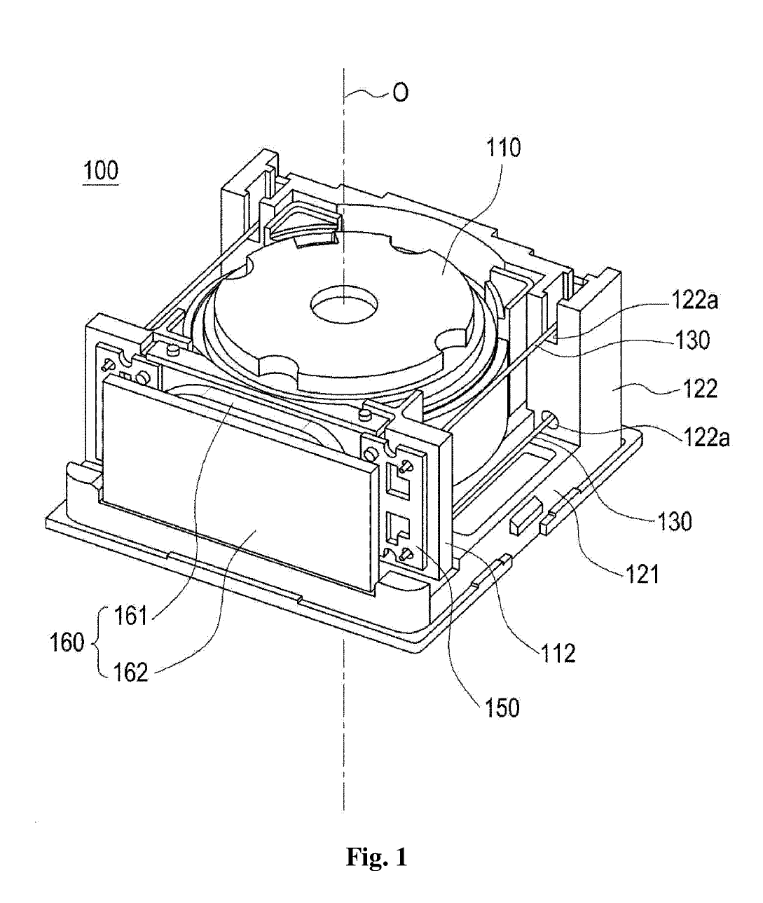

### BEST MODE

In the present invention, even when a support spring and a driving source configured to generate driving force are located on one side of a lens, when the lens vertically moves along an optical axis direction, a displacement by which a lens center is moved in a horizontal direction from an initial position thereof is minimized, and thus, the lens center is maintained on a line of an initial optical axis, so that imaging quality may be improved.

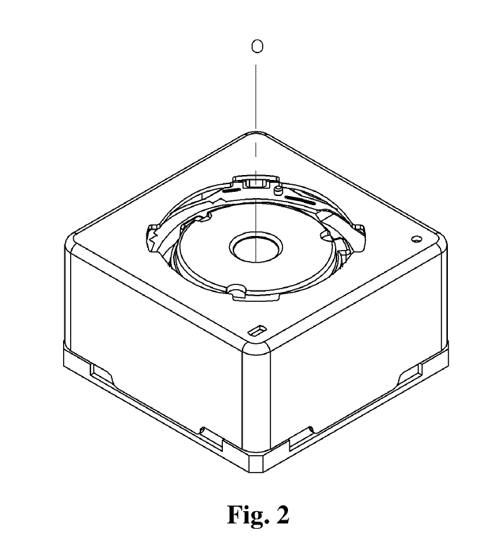

Hereinafter, the present invention will be described in detail with reference to the accompanying drawings. In the detailed description of the present invention, a vertical direction is based on the drawings, and may be changed depending on a location from which an object is viewed. Further, a horizontal direction means a direction that is perpendicular to an optical axis, and an initial optical axis means an optical axis of a lens at an initial position which corresponds to a state in which a movable part is stopped before being moved. Further, a camera module for a mobile terminal according to the present invention includes an actuator having a structure and characteristics as described below, and a detailed description thereof will be omitted. A camera actuator for a mobile terminal according to the embodiment of the present invention or a camera module for a mobile terminal, which includes such a camera actuator, includes a holder 10, a cover 20, a fixed part 30, a movable part 40, an elastic part 50, and a lower elastic part 60, as illustrated in FIGS. 2 to 9. Hereinafter, the elastic part 50 is indicated by an upper elastic part 50 to distinguish the elastic part 50 from the lower elastic part 60. The camera actuator for a mobile terminal according to the present embodiment includes both the upper elastic part 50 and the lower elastic part 60. However, in some cases, the camera actuator for a mobile terminal may also include only one elastic part 50 which is not divided into upper and lower parts.

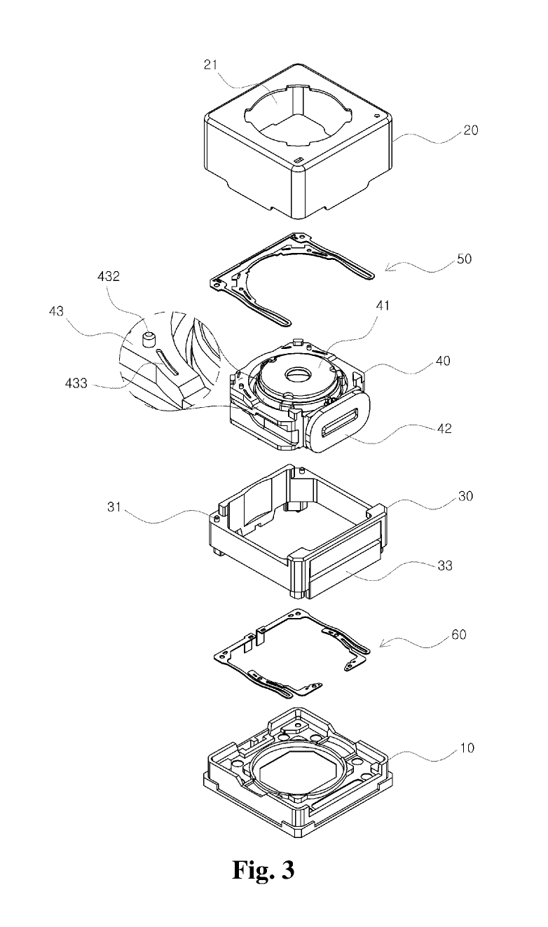

As illustrated in FIGS. 2 and 3, the holder 10 is mounted on a mobile terminal through a circuit board including an image sensor, and the fixed part 30 is mounted on an upper portion of the holder 10. Further, the cover 20 is coupled to the holder 10 to cover the fixed part 30, the movable part 40, the elastic part 50, and the lower elastic part 60, and has a through-hole 21 to allow a light beam to pass through a lens.

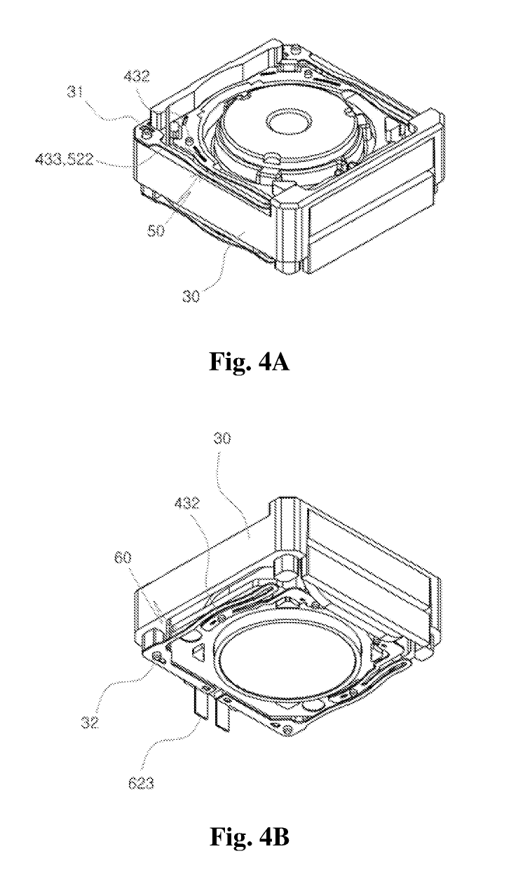

As illustrated in FIG. 3, the fixed part 30 has approximately a hexahedral shape, an upper portion and a lower portion of which are opened. Further, as illustrated in FIG. 4, an upper fixing protrusion 31 and a lower fixing protrusion 32 protrude from an upper portion and a lower portion of one side of the fixed part 30, respectively, and the elastic parts 50 and 60 are coupled to the upper fixing protrusion 31 and the lower fixing protrusion 32. Further, a magnet 33 is mounted on an opposite surface of the fixed part 30, which is located to be opposite to the one side of the fixed part 30. The magnet 33 forms a magnetic field around a coil part 42.

As illustrated in FIG. 3, the movable part 40 is located inside the fixed part 30, has a lens assembly 41 including a plurality of lenses, which is coupled thereto, and moves in a vertical direction along a direction of an optical axis O together with the lens assembly 41. The coil part 42 that is opposite to the magnet 33 is mounted on such a movable part 40, and when a current is generated in the coil part 42, an electromagnetic force is generated.

In the embodiment of the present invention, the magnet 33 is mounted on the fixed part 30, and the coil part 42 is mounted on the movable part 40. However, the mounting positions of the magnet 33 and the coil part 42 are not necessarily limited thereto. According to various embodiments of the present invention, to allow the magnet 33 and the coil part 42 to face each other, the coil part 42 is mounted on the fixed part 30 and the magnet 33 is mounted on the movable part 40, so that an electromagnetic force may be generated.

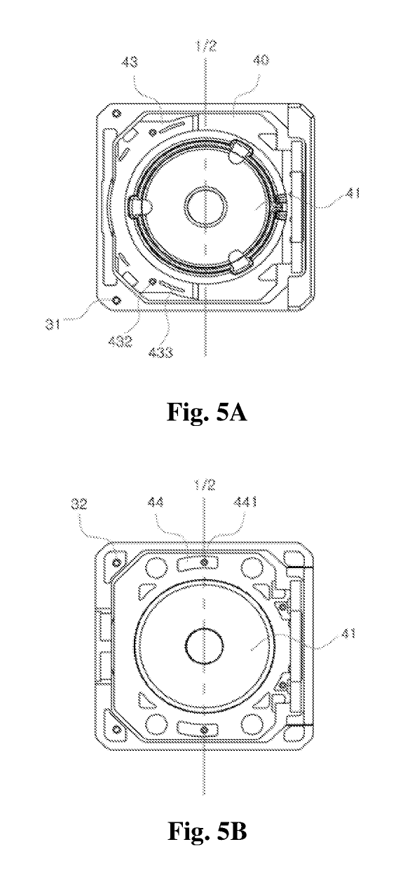

Further, an upper mounting part 43 protrudes from an upper portion of the movable part 40. As illustrated in FIG. 5(a), the upper mounting part 43 is located at the upper portion of the movable part 40, which is located on one side of the fixed part 30 with respect to a half point of the lens assembly 41 passing through a lens center on a plane. In the drawing, the upper mounting part 43 is formed on the left side of the half point. Such an upper mounting part 43 forms a step with an upper surface of the movable part 40 to define a space in which the upper elastic part 50 may be elastically deformed. Further, an upper assembly protrusion 432 and a filling groove 433 are formed in the upper mounting part 43.

Further, a lower mounting part 44 protrudes from a lower portion of the movable part 40, and a lower assembly protrusion 441 protrudes from the lower mounting part 44. As illustrated in FIG. 5(b), the lower assembly protrusion 441 is formed at the half point of the lens assembly 41 passing through the lens center on a plane.

The upper elastic part 50 and the lower elastic part 60 are leaf springs connecting the fixed part 30 and the movable part 40 to elastically support the movable part 40.

The upper elastic part 50 is located on the movable part 40, and includes a (upper) first elastic part 51 and a (upper) second elastic part 52.

The first elastic part 51 is mounted on the fixed part 30 as one end of the first elastic part 51 is biased from the lens, and protrudes in a first direction. Further, the second elastic part 52 is bent from an opposite end of the first elastic part 51 and protrudes in a second direction that is opposite to the first direction. That is, the first elastic part 51 protrudes toward the opposite side of the fixed part 30, on which the magnet 33 is mounted, as the one end of the first elastic part 51 is mounted on an upper end of one side of the fixed part 30. Further, the second elastic part 52 is bent from the opposite end of the first elastic part 51 to protrude toward the one side of the fixed part 30, and is mounted on the movable part 40.

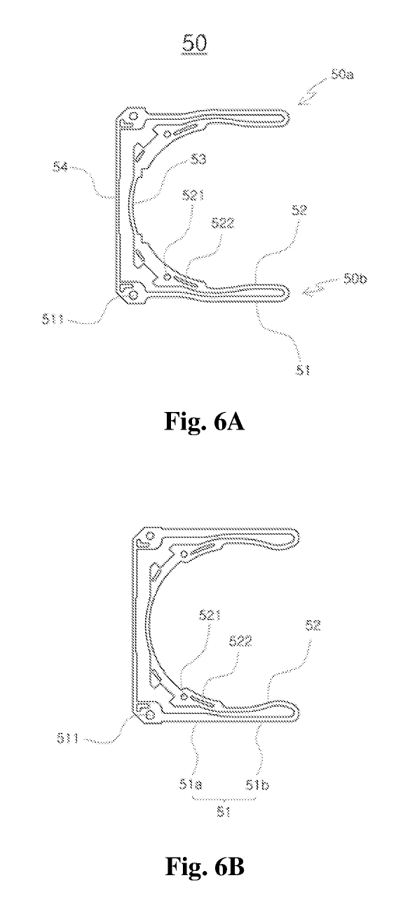

In detail, as illustrated in FIG. 6(a), a fixing hole 511 into which the upper fixing protrusion 31 is inserted is formed at the one end (a left end in the drawing) of the first elastic part 51, so that the one end of the first elastic part 51 is fixed to the upper end of the one side of the fixed part 30. Further, an assembly hole 521 into which the upper assembly protrusion 432 is inserted and an adhesion hole 522 corresponding to the filling groove 433 are formed in the second elastic part 52. Adhesive is filled in the filling groove 433 and the adhesion hole 522 to fix the second elastic part 52 to the upper mounting part 43. Accordingly, the remaining portion of the second elastic part 52 except for a portion of the second elastic part 52, which is fixed to the upper mounting part 43, is spaced apart from the movable part 40.

Such a second elastic part 52 is maintained in a horizontal state in an initial state in which an electromagnetic force is not applied. Thereafter, when the movable part 40 is raised due to generation of the electromagnetic force, the remaining portion of the second elastic part 52 except for the portion of the second elastic part 52, which is fixed to the upper mounting part 43, is elastically deformed. In an optimal embodiment of the present invention, any one portion of the second elastic part 52 with respect to the half point of the lens assembly 41 is fixed to the upper mounting part 43 and the other portion of the second elastic part 52 is elastically deformed. However, according to an internal structure of the actuator and a coupling structure of components of the actuator, a reference point at which the second elastic part 52 is divided into the fixed portion and the elastically deformed portion may be spaced apart from the half point of the lens assembly 41 by a predetermined distance without coinciding with the half point of the lens assembly 41.

The above-described upper elastic part 50 may be divided into a left elastic part 50a and a right elastic part 50b, which are located on opposite sides of the movable part 40 with respect to the movable part 40. Further, ends of the second elastic part corresponding to the left elastic part 50a and the second elastic part corresponding to the right elastic part 50b are connected to each other through a first bridge 53. Further, ends of the first elastic part corresponding to the left elastic part 50a and the first elastic part corresponding to the right elastic part 50b are connected to each other through a second bridge 54. The left elastic part 50a and the right elastic part 50b are configured to distinguish portions of the elastic part, which are located on opposite sides of the movable part 40, and the elastic part is not necessarily divided into a left part and a right part.

Meanwhile, as illustrated in FIG. 6(b), the first elastic part 51 may be divided into a first elastically deformed part 51a and a second elastically deformed part 51b. The first elastically deformed part 51a has one end mounted on an upper end of one side of the fixed part 30, and protrudes in the first direction, and the second elastically deformed part 51b has one end extending from an opposite end of the first elastically deformed part 51a and protrudes in the first direction. Further, the second elastic part 52 is bent from the second elastically deformed part 51b. Here, the width of the second elastically deformed part 51b is smaller than the width of the first elastically deformed part 51a. A difference between the width of the first elastically deformed part 51a and the width of the second elastically deformed part 51b causes a difference between a deformation of the first elastically deformed part 51a and a deformation of the second elastically deformed part 51b, which results from an electromagnetic force. Thus, deformations of portions of the first elastic part 51 differ from each other, so that an optimal behavior of the movable part 40 may be implemented. The optimal behavior of the movable part 40 is that while the movable part 40 vertically moves in a horizontal state without tilting, the lens center is maintained on the line of the initial optical axis without changing a horizontal position of the lens center according to the vertical movement of the movable part 40. In some cases, the width of the second elastically deformed part 51b may be larger than the width of the first elastically deformed part 51a.

The lower elastic part 60 is located below the movable part 40, and is divided into a first lower elastic part 61, a second lower elastic part 62, and a lead part 63.

The first lower elastic part 61 is mounted on the fixed part 30 as one end of the first lower elastic part 61 is biased from the lens, and protrudes in the first direction. Further, the second lower elastic part 62 is bent from an opposite end of the first elastic part 61, protrudes in the second direction, and is mounted on the movable part 40. That is, the first lower elastic part 61 protrudes toward the opposite side of the fixed part 30, on which the magnet 33 is mounted, as the one end of the first lower elastic part 61 is mounted on a lower end of one side of the fixed part 30. Further, the second lower elastic part 62 is bent from the opposite end of the first lower elastic part 51 to protrude toward the one side of the fixed part 30, and is mounted on the movable part 40. Further, the lead part 63 extends from the second lower elastic part 62 to be electrically connected to the coil part 42. Further, a terminal 623 is formed at one end of the first lower elastic part 61 so that a power source is connected to the coil part 42 through the lower elastic part 60.

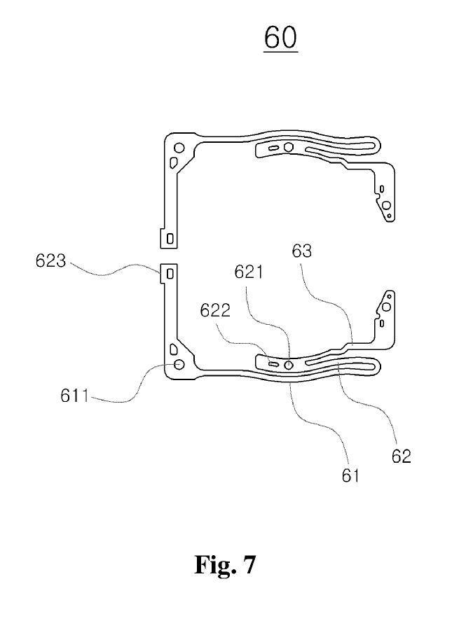

In detail, as illustrated in FIG. 7, a fixing hole 611 into which the lower fixing protrusion 32 is inserted is formed at the one end of the first lower elastic part 61, so that the one end of the first lower elastic part 61 is fixed to the lower end of the one side of the fixed part 30. Further, an assembly hole 621 into which the lower assembly protrusion 441 is inserted is formed in the second lower elastic part 62. Further, an adhesion hole 622 may be formed in the second lower elastic part 62.

Like the upper elastic part 50, the lower elastic part 60 may be also divided into two lower elastic parts 60 located on opposite sides with respect to the movable part 40. However, the two lower elastic parts 60 are not connected to each other through a bridge.

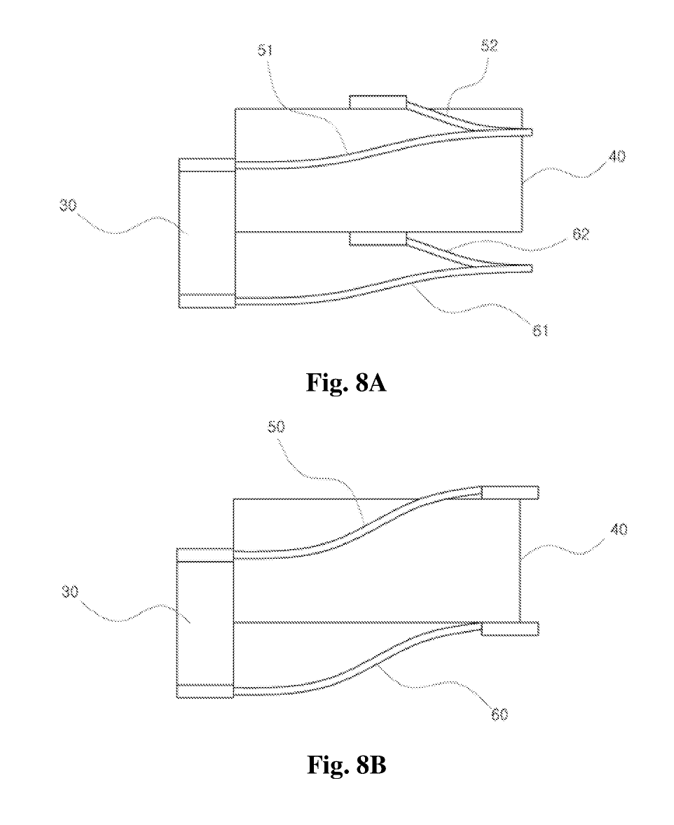

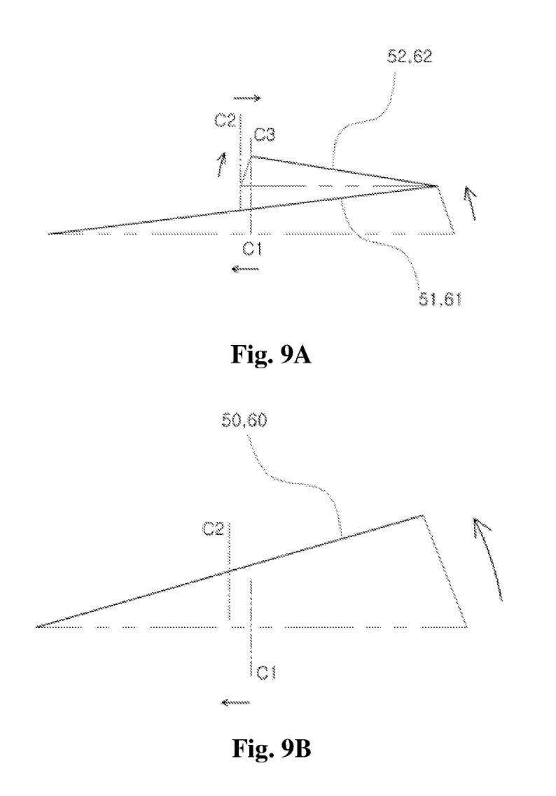

Operations of the upper elastic part 50 and the lower elastic part 60, which have been described above, will be described below with reference to FIGS. 8(a) and 9(a). Because the operation of the lower elastic part 60 is similar to the operation of the upper elastic part 50, the operation of the upper elastic part 50 will be mainly described.

First, when an electromagnetic force is generated, the first elastic part 51 is elastically deformed with respect to one fixed end thereof, and thus an opposite end of the first elastic part 51 is raised. When the electromagnetic force is generated, the second elastic part 52 is elastically deformed with respect to the opposite end of the first elastic part 51, and thus the movable part 40 is raised.

Further, when the movable part 40 vertically moves by the electromagnetic force, the lens center is transversely moved toward the one side of the fixed part by a predetermined distance by the elastically deformed first elastic part 51 (C1->C2), and at the same time, the lens center is transversely moved toward the opposite side of the fixed part 30 by a predetermined distance by the elastically deformed second elastic part 52 (C2->C3). That is, as the transverse movement direction of the lens center according to the elastic deformation of the first elastic part 51 and the transverse movement direction of the lens center according to the elastic deformation of the second elastic part 52 are opposite to each other, a change in a transverse position of the lens center according to the vertical movement of the movable part 40 is minimized, so that the lens center may vertically move on the line of the initial optical axis without deviating from the initial optical axis. Actually, the position of C1 and the position of C2 may not accurately coincide with each other. However, the lens center is always as close as possible to the initial optical axis, so that a difference between the position of C1 and the position of C2 is minimized.

Accordingly, when the lens vertically moves along an optical axis O together with the movable part 40, the lens center is maintained on the line of the initial optical axis by minimizing a displacement by which the lens center is moved in a horizontal direction from an initial position thereof, and distortion of the optical axis O is prevented, so that imaging quality may be improved.

However, as illustrated in FIGS. 8(b) and 9(b), in the conventional cantilever-type camera actuator for a mobile terminal, as the movable part 40 is raised, the lens center is moved from C1 to C2 while the upper elastic part 50 and the lower elastic part 60 are elastically deformed, and thus, the lens center and the initial optical axis are spaced apart from each other by an interval between C1 and C2, and do not coincide with each other.

Further, in the conventional cantilever-type camera actuator for a mobile terminal, because an elastically deformed angle is large when the movable part 40 is raised, distortion of the optical axis is relatively large. However, in the camera actuator for a mobile terminal according to the embodiment of the present invention, even when the movable part 40 is raised by the same distance, the first elastic part 51 and 61 and the second elastic part 52 and 62 are separately and elastically deformed by predetermined angles, so that distortion of the optical axis may be minimized.

The camera actuator and the camera module for a mobile terminal according to the present invention are not limited to the above-described embodiment, and various modifications may be implemented within the technical spirit of the present invention.

1. A camera actuator for a mobile terminal, comprising:
an elastic part comprising a first elastic part connected to a fixed part to extend in a first direction, and a second elastic part bent from an extending end of the first elastic part, extending in a second direction that is opposite to the first direction, and having an extending end connected to a movable part.

2. The camera actuator of claim 1, wherein when the movable part is raised, as the first elastic part is elastically deformed while taking one end of the first elastic part, which is fixed to the fixed part, as a support point, an opposite end of the first elastic part is raised, and as the second elastic part is elastically deformed while taking an inflection point connected to the first elastic part as a support point, ends of the second elastic part are raised, so that a lens center of a lens assembly is always close to an initial optical axis.

3. The camera actuator of claim 1, wherein the elastic part is divided into a left elastic part and a right elastic part, which are located on opposite sides with respect to the movable part, and ends of the second elastic part of the left elastic part and the second elastic part of the right elastic part are connected to each other through a first bridge.

4. The camera actuator of claim 1, wherein an upper mounting part, on which the second elastic part is fixedly mounted, protrudes from an upper portion of the movable part to form a step with the upper surface of the movable part, and
wherein the remaining portion of the second elastic part except for a portion of the second elastic part, which is located above the movable part and is fixed to the upper mounting part, is spaced apart from the movable part.

5. The camera actuator of claim 4, wherein an upper assembly protrusion and a filling groove are formed in the upper mounting part,
wherein an assembly hole into which the upper assembly protrusion is inserted and an adhesion hole corresponding to the filling groove are formed in the second elastic part, and
wherein adhesive is filled in the filling groove and the adhesion hole to fix the second elastic part to the upper mounting part.

6. The camera actuator of claim 1, wherein the first elastic part comprises,
a first elastically deformed part having one end mounted on the fixed part, and protruding in the first direction, and
a second elastically deformed part having one end extending from an opposite end of the first elastically deformed part, and protruding in the first direction,
wherein the second elastic part is bent from the second elastically deformed part to protrude in the second direction, and
wherein the width of the first elastically deformed part and the width of the second elastically deformed part are different from each other.

7. The camera actuator of claim 1, further comprising:
a lower elastic part located below the movable part,
wherein the lower elastic part comprises,
a first lower elastic part connected to the fixed part and extending in the first direction,
a second lower elastic part bent from an extending end of the first lower elastic part, extending in the second direction, and connected to the movable part, and
a lead part extending from the second lower elastic part and electrically connected to a coil part.

8. A camera module for a mobile terminal, comprising:
an elastic part comprising a first elastic part connected to a fixed part to extend in a first direction, and a second elastic part bent from an extending end of the first elastic part, extending in a second direction that is opposite to the first direction, and having an extending end connected to a movable part,
wherein when the movable part is raised, as the first elastic part is elastically deformed while taking one end of the first elastic part, which is fixed to the fixed part, as a support point, an opposite end of the first elastic part is raised, and as the second elastic part is elastically deformed while taking an inflection point connected to the first elastic part as a support point, ends of the second elastic part are raised, so that a lens center of a lens assembly is always close to an initial optical axis.
